(19) United States
(12) Patent Application Publication
(10) Pub. No.: US 2026/0260319 A1
(43) Pub. Date: Sep. 3, 2026

(54) METHOD AND APPARATUS FOR PROCESSING VIDEO DATA, TRAINING METHOD, AND ELECTRONIC DEVICE THEREOF

(71) Applicant: BOE TECHNOLOGY GROUP CO., LTD., Beijing (CN)

(72) Inventor: Xuan SUN, Beijing (CN)

(73) Assignee: BOE TECHNOLOGY GROUP CO., LTD., Beijing (CN)

(21) Appl. No.: 18/993,249

(22) PCT Filed: Jun. 30, 2023
(86) PCT No.: PCT/CN2023/104578

§ 371 Date: Jan. 10, 2025

(30) Foreign Application Priority Data
Jan. 20, 2023 (CN) 202310096185.X

(51) Int. Cl. G06T 5/60; G06T 5/50; G06V 10/774; G06V 10/80; G06V 10/82; G06V 20/40

(52) U.S. Cl. CPC G06T 5/60; G06T 5/50; G06V 10/774; G06V 10/806; G06V 20/46; G06V 20/49; G06T 2207/10016; G06T 2207/20081; G06T 2207/20084; G06V 10/82

(57) ABSTRACT

A method for processing video data, an apparatus for processing video data, a training method, an electronic device, a computer-readable storage medium and a computer program product are disclosed. The video data includes a plurality of video frames, and the method includes: dividing the plurality of video frames to generate at least one video frame groups; determining reference information of at least one video frame in each video frame group of the at least one video frame groups based on information of all video frames in the video frame group; and determining an enhanced video frame for the at least one video frame based on the reference information of the at least one video frame in the video frame group and the information of the at least one video frame.

The present application claims the priority of Chinese Patent Application No. 202310096185.X, filed on Jan. 20, 2023, the disclosure of which is incorporated herein by reference in its entirety as part of the present application.

### TECHNICAL FIELD

The present disclosure relates to a method for processing video data, an apparatus for processing video data, a training method, an electronic device, a computer-readable storage medium and a computer program product.

### BACKGROUND

With the diversification and high standardization of the video subscribers' demands, especially the urgent demands for ultra-high definition video resources, the efficient coding technology for video data is faced with great challenges. The video data transmitted to the user terminal is often compressed video data. For video data obtained by decoding such compressed video data, prevalently there are obvious compression artifacts, which severely affects the subjective effect of the video. In addition, with the vigorous development of the manufacturing industry for display device, ultra-high definition display terminals such as 4K, 8K and the like have walked into hundreds of thousands of homes. The artifacts and distortions in the decoded compressed video would be further amplified on the ultra-high definition display device. Therefore, it is necessary to further improve the quality enhancement technology aimed to compressed videos.

### SUMMARY

The embodiments of the present disclosure provide a method and apparatus for processing video data, a training method, an electronic device, a computer-readable storage medium and a computer program product.

An embodiment of the present disclosure provides a method for processing video data, the video data includes a plurality of video frames, the method includes: dividing the plurality of video frames in chronological order to generate at least one video frame groups; determining reference information of one or more video frames in each video frame group of the at least one video frame groups based on information of all video frames in the video frame group; and determining an enhanced video frame for the one or more video frames based on the reference information of the one or more video frames in the video frame group and the information of the one or more video frames.

An embodiment of the present disclosure provides an apparatus for processing video data, the video data includes a plurality of video frames, the apparatus includes a division module, a reference information generation module and an information fusion module, in which the division module is configured to divide the plurality of video frames in chronological order to generate at least one video frame groups; the reference information generation module is configured to determine reference information of one or more video frames in each video frame group of the at least one video frame groups based on information of all video frames in the video frame group; and the information fusion module is configured to determine an enhanced video frame for the one or more video frames based on the reference information of the one or more video frames in the video frame group and the information of the one or more video frames.

An embodiment of the present disclosure provides a training method, which is used for training the apparatus according to the embodiments of the present disclosure, the training method includes: acquiring a true value of a video frame in sample video data; encoding and decoding the video frame in the sample video data to acquire a reconstructed frame corresponding to the video frame in the sample video data; predicting an enhanced video frame for the reconstructed frame using the apparatus under training; calculating a value corresponding to a loss function based on the enhanced video frame and the true value of the video frame; and adjusting parameters for respective convolution kernels and respective neurons in the apparatus based on the value corresponding to the loss function, so that the value corresponding to the loss function converges.

An embodiment of the present disclosure provides an electronic device, which includes: a processor and a memory, in which the memory stores a computer executable program, when the computer executable program is executed by the processor, performs the above-described method.

An embodiment of the present disclosure provides a device, which includes: a processor and a memory, the memory stores computer instructions, when the computer instructions executed by the processor, implement the above-described method.

An embodiment of the present disclosure provides a computer-readable storage medium having stored thereon computer instructions, when the computer instructions is executed by a processor, implement the above-described method.

According to another aspect of the present disclosure, there is provided a computer program product or computer program, the computer program product or the computer program includes computer instructions, the computer instructions are stored in a computer-readable storage medium. A processor of a computer device reads the computer instructions from the computer-readable storage medium, and the processor executes the computer instructions, so that the computer device performs the methods provided in the above respective aspects or various alternative implementations of the above respective aspects.

The embodiments of the present disclosure can, with a low calculational burden, significantly enhance texture details of the decoded compressed video and reduce the artifacts and distortions in the decoded compressed video, thereby significantly enhancing the quality of data of the decoded compressed video. The embodiments of the present disclosure can also be deployed in a display terminal in a lightweight manner, providing a better use experience for the users of ultra-high definition display terminals.

### BRIEF DESCRIPTION OF DRAWINGS

In order to more clearly illustrate the technical schemes of the embodiments of the present disclosure, the accompanying drawings is briefly introduced below. Obviously, the accompanying drawings described below merely relate to some of the embodiments of the present disclosure, and are not limited to the present disclosure.

FIG. 1 illustrates a schematic diagram of an application scenario according to an embodiment of the present disclosure.

FIG. 2 is a schematic diagram illustrating an example for a scenario for reasoning and training a model for processing video data according to an embodiment of the present disclosure.

FIG. 3 is a flowchart illustrating a method for processing video data according to an embodiment of the present disclosure.

FIG. 4 is a schematic diagram illustrating an apparatus for processing video data according to an embodiment of the present disclosure.

FIG. 5 is yet another schematic diagram illustrating an apparatus according to an embodiment of the present disclosure.

FIG. 6 is a schematic diagram illustrating a temporal-spatial feature extraction module according to an embodiment of the present disclosure.

FIG. 7 is a schematic diagram illustrating an example for training a model for processing video data according to an embodiment of the present disclosure.

FIG. 8 is a schematic diagram illustrating an example for a test effect of a scheme according to an embodiment of the present disclosure.

FIG. 9 illustrates a schematic diagram of an electronic device according to an embodiment of the present disclosure.

FIG. 10 illustrates an architecture diagram of a computing device according to an embodiment of the present disclosure.

FIG. 11 illustrates a schematic diagram of a computer-readable storage medium according to an embodiment of the present disclosure.

### DETAILED DESCRIPTION

In order to make the objects, technical schemes and advantages of the present disclosure more obvious, example embodiments according to the present disclosure will be described in detail below with reference to the accompanying drawings. Obviously, the described embodiments are merely a part of the embodiments of the present disclosure, not all of the embodiments of the present disclosure, and it should be understood that the present disclosure is not limited by the example embodiments described herein.

In the specification and the drawings, substantially like or similar steps and elements are denoted by like or similar reference numerals, and repetitive descriptions of such steps and elements will be omitted. Meanwhile, in the description of the present disclosure, terms “first”, “second” and so on are only used to distinguish descriptions, but cannot be understood as indicating or implying relative importance or order.

In order to facilitate the description of the present disclosure, the concepts related to the present disclosure are introduced below.

The present disclosure can implement a method for processing video data by using a model for processing video data. The models mentioned below, such as three-dimensional convolutional neural network, temporal-spatial information filter module, extraction module, temporal-spatial feature extraction module, information fusion module and the like, are all constituent modules of the model for processing video data. Optionally, various models or modules available for the embodiments of the present disclosure may be artificial intelligence models, especially artificial-intelligence-based neural network models. Generally, the artificial-intelligence-based neural network model is implemented as an acyclic graph, in which neurons are arranged in different layers. Generally, the neural network model includes an input layer and an output layer, the input layer and the output layer are separated by at least one hidden layer. The hidden layer transforms an input received by the input layer into a representation useful for generating an output in the output layer. Network nodes (i.e., neurons) are fully connected to nodes in adjacent layers via edges, and there is no edge between nodes in each layer. The data received at the node of the input layer of the neural network is propagated to the node of the output layer via any of the hidden layer, activation layer, pooling layer, convolution layer, etc. The input and output of the neural network model may take various forms, which is not limited by the present disclosure.

The schemes provided by the embodiments of the present disclosure relate to technologies such as artificial intelligence and machine learning, and is specifically illustrated by the following embodiments.

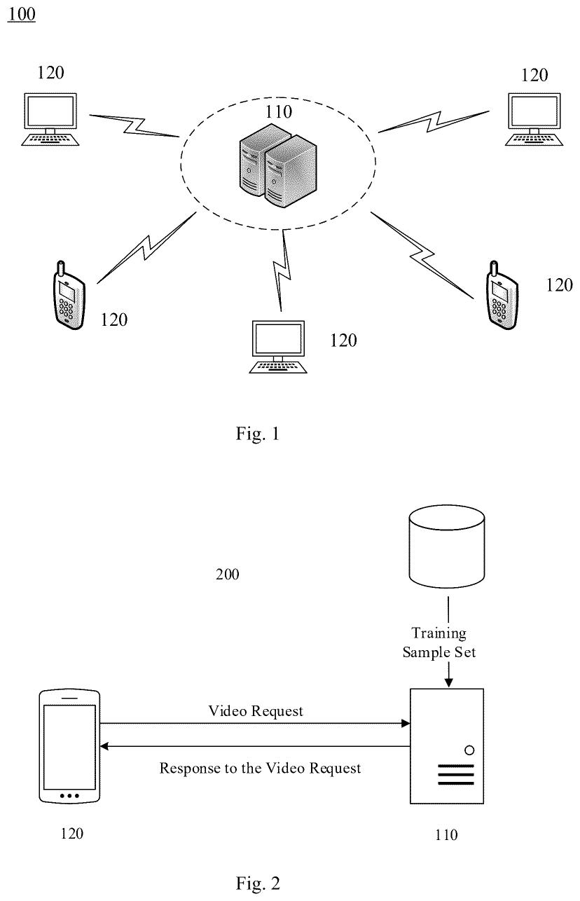

First, an application scenario for a method and a corresponding apparatus according to an embodiment of the present disclosure is described with reference to FIG. 1. FIG. 1 illustrates a schematic diagram of an application scenario 100 according to an embodiment of the present disclosure, in which a server 110 and a plurality of user terminals 120 are schematically shown.

The model for processing video data according to the embodiment of the present disclosure may be integrated in various electronic devices, for example, any electronic device among the server 110 and the plurality of user terminals 120 in FIG. 1. For example, the model for processing video data may be integrated in the user terminal 120. The user terminal 120 may be a mobile phone, a tablet computer, a notebook computer, a desktop computer, a Personal Computer (PC), a smart speaker or a smart watch and the like, but it is not limited thereto. For another example, the model for processing video data may also be integrated in the server 110. The server 110 may be an independent physical server, or a cluster of servers 110 or a distributed system composed of a plurality of physical servers, or a cloud server 110 providing basic cloud computing services. The terminal and the server 110 may be directly or indirectly connected by means of wired or wireless communication, which is not limited herein by the present disclosure.

It can be understood that, the apparatus for reasoning by applying the model for processing video data in the embodiment of the present disclosure may be a terminal, or the server 110, or a system composed of the terminal and the server 110. The method for processing video data in the embodiment of the present disclosure may be performed on the terminal, or on the server 110, or commonly by both the terminal and the server 110.

FIG. 2 is a schematic diagram illustrating an example for a scenario 200 for reasoning and training a model for processing video data according to an embodiment of the present disclosure.

In the training stage, the server 110 may train the model for processing video data based on a training sample set. After the training is completed, the server 110 may deploy the trained model for processing video data into one or more servers 110 (or cloud services) or user terminals 120, to provide artificial intelligence services related to enhancement in video data.

It is worth noting that the training sample set shown in FIG. 2 may also be updated in real time. For example, the user may rate the quality of the video data. For example, when the user considers that the quality of the video data is high and gives a high score to the video data, the server 110 may take the video data as a positive sample for training the model for processing video data in real time. When the user gives a low score to the video data, the server 110 may take the video data as a negative sample for training the model for processing video data in real time.

The training sample set shown in FIG. 2 may also be set in advance. For example, the server 110 may capture high-definition video data already existing in the current Internet environment, and then use such high-definition video data as the training sample set for training. For example, referring to FIG. 2, the server 110 may acquire high-definition video data from a database, and then take it as the training sample set for the model for processing video data. Of course, the present disclosure is not limited to this.

In the reasoning stage, it is assumed that the user terminal 120 has installed thereon an application for playing video data and processing video data (hereinafter referred to as video application). The user terminal 120 may indicate video data to be played to the video application. Then the user terminal 120 may transmit a video request to the server 110 corresponding to the application over the network, to request compressed video data. It is worth noting that in various embodiments of the present disclosure, compressing video data is also referred to as encoding video data, and decompressing video data is also referred to as decoding video data. Therefore, compressed video data may also be referred to as encoded video data, and decompressed video data may also be referred to as decoded video data.

In an example embodiment, the model for processing video data is deployed in the user terminal 120. After receiving the video request, the server 110 may send the compressed video data to the user terminal 120. The user terminal 120 would correspondingly perform a decompressing operation (decoding operation) on the compressed video data, then perform a quality enhancing operation on the decompressed and decoded video data by using the video data processing model according to the embodiment of the present disclosure, and finally present the quality enhanced video data.

In yet another example embodiment, the model for processing video data is deployed in the server 110. The server 110 may correspondingly perform a decompressing operation (decoding operation) on the compressed video data, then perform a quality enhancing operation on the decompressed video data by using the video data processing model according to the embodiment of the present disclosure, and then sends the quality enhanced video data to the user terminal 120.

In the current academic world and industrial field, the decoded video enhancing technology prevalently adopts a network design of video denoising and video deblurring, but not analyzes the characteristics of decoded video data differentiable from other video data and carries out a targeted design. Due to the difficulty in the task of decoded video enhancement, in order to guarantee the effect of enhancement, a decoded video enhancement model is prevalently designed to be enormous and complex, which brings great difficulty to actual deployment. Therefore, it is necessary to enhance the quality of the existing decoded video.

Based on this, the present disclosure provides a method for processing video data, the video data includes a plurality of video frames, the method includes: dividing the plurality of video frames to generate at least one video frame groups; determining reference information of one or more video frames in each video frame group of the at least one video frame groups based on information of all video frames in the video frame group; and determining an enhanced video frame for the one or more video frames based on the reference information of the one or more video frames in the video frame group and the information of the one or more video frames.

Various embodiments of the present disclosure provide a lightweight scheme for enhancing quality of decoded video, which makes full use of the characteristics of the video data processed by the video coding technology to enhance the quality of the decoded video data, so as to, with a low calculational burden, significantly enhance the texture details of the decoded video data and reduce the artifacts and distortions in the decoded video data, thereby significantly enhancing the quality of the decoded video data. The embodiments of the present disclosure can also be deployed in a display terminal in a lightweight manner, providing a better use experience for the users of ultra-high definition display terminal.

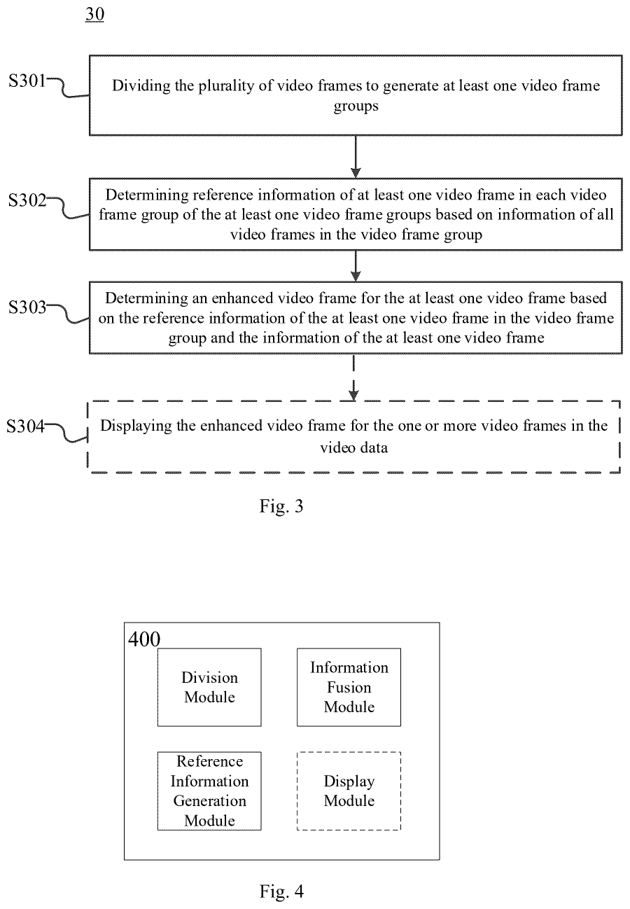

All or part of the embodiments according to the present disclosure are introduced in more detail below with reference to FIG. 3 to FIG. 11.

FIG. 3 is a flowchart illustrating a method 30 for processing video data according to an embodiment of the present disclosure.

The method 30 for processing video data according to the embodiment of the present disclosure can be applied to any electronic device. It can be understood that an electronic device may be various kinds of hardware device, such as personal digital assistant (PDA), audio/video device, mobile phone, MP3 player, personal computer, laptop computer, server 110 and the like. For example, the electronic device may be the server 110 and the user terminal 120 in FIG. 1, and the like. Hereinafter, the present disclosure is illustrated by taking the user terminal 120 as an example, and it should be understood by those skilled in the art that the present disclosure is not limited to this.

The video data processed by the method for processing video data 30 according to the embodiment of the present disclosure may be video data conforming to any video coding standard. As described with reference to FIG. 2, the video data may be decompressed (decoded) video data. Since compressed video data is derived by encoding the original video data, with data volume significantly reduced, it is more conducive to transmission of video data. However, after decoding the compressed video data, a plurality of video frames (also known as reconstructed frames) would be obtained, and there are often some texture details lost in these video frames, and there are certain distortions.

The method 30 for processing video data according to the embodiment of the present disclosure may process video data including a plurality of video frames (also known as reconstructed frames). A video frame refers to the smallest unit of a single image picture in an image animation. A frame of video frame is a still picture, and consecutive video frames form animations, such as TV images and the like. Each frame is a still image, and displaying the plurality of video frames quickly and consecutively forms the illusion of motion.

For example, in the case that the video data according to the embodiments of the present disclosure conforms to the coding standard, any video frame (i.e., picture) in the video data may be an I frame, a P frame or a B frame. I frame is an internally encoded frame (also referred to as a completely encoded frame), and its quality of picture is the highest. P frame is a forward predicted frame, which is a frame predicted by referring to its preceding video frame, usually, it only includes the information of difference between itself and its preceding video frame. B frame is a bi-directionally predicted frame, which is a frame predicted by referring to its preceding and subsequent video frames, usually, it only includes the information of difference between itself and its preceding and subsequent video frames. Among the above-described three types of frames, I frame has the highest quality. It should be understood by those skilled in the art that the above coding standards are only examples, which is not limited by the present disclosure.

For example, the method 30 according to the embodiment of the present disclosure includes the following operations S301 to S303. Of course, the present disclosure can also include more or less operations, which is not limited by the present disclosure.

First, in operation S301, dividing the plurality of video frames to generate at least one video frame groups.

Optionally, the plurality of video frames may be divided in chronological order to generate the at least one video frame groups. There is usually a correlation among the plurality of video frames arranged in chronological order. Taking the video data conforming to a certain coding standard as an example, it usually uses an I frame (also referred to as reference frame or key frame) to predict a fixed number of subsequent P frames and B frames, so these P frames and B frames are all associated with the I frame. For the video data conforming to another coding standard, similar frames are taken as a segment of GOP image group. Each GOP image group includes an I frame, and the respective frames in the group are predicted and encoded based on the I frame. No matter what coding standard the video data conforms to, it may be based on pixel blocks, so there are a lot of search and utilization situations for similar pixel blocks in the coding process. Therefore, after the video data conforming to the coding standards is compressed, the correlation among the respective frames increases.

For example, in uncompressed video data, a video frame is often only associated with 7 to 15 video frames preceding and subsequent to it. But in compressed video data, a video frame is often associated with more frames. According to statistics, in compressed video data, a video frame may be associated with fifteen or even more or more than twenty video frames. Of course, the present disclosure is not limited to this. Therefore, in some embodiments of the present disclosure, the plurality of video frames in the video data may be divided in chronological order to generate a plurality of video frame groups, with each group includes more than twenty frames. Each of the video frame groups includes more than twenty video frames, including at least one key frame (I frame). The following illustration is made with each video frame group including 24 frames as an example, and it should be understood by those skilled in the art that the present disclosure is not limited to this.

Next, in operation S302, determining reference information of at least one video frame in each video frame group of the at least one video frame groups based on information of all video frames in the video frame group.

In the process of decoding encoded video data, the key frames (e.g., I frames) are often intra-decoded, so as to restore high-quality key frames. Then, P frames and B frames are decoded and restored in a manner combining intra-decoding and inter-decoding. Therefore, in the decoding operation (decompressing operation), for respective decoded video frames, a data volume of 1-3 video frames is considered at most. In order to reduce distortions in the respective decoded video frames, in various embodiments of the present disclosure, information of all video frames in a video frame group is comprehensively considered, and reference information for one or more video frames in the video frame group is generated based on the information of all video frames.

In some optional implementations, reference information of each of video frames in each video frame group of the at least one video frame groups may be determined based on information of all video frames in the video frame group. Since the information of 24 video frames in the video frame group is considered for each of the video frames, the reference information involves more video frames as well as video frames that are farther away from the current frame in comparison with the information of no more than 15 video frames considered in a traditional scheme, so the reference information may be referred to as long-distance chronological information. Of course, the present disclosure is not limited to this.

Optionally, in an example embodiment of the present disclosure, operation S302 includes: determining a pre-extraction feature of each of the video frames in each video frame group of the at least one video frame groups based on the information of all video frames in the video frame group, to acquire the pre-extraction features of all video frames in the video frame group; and determining the reference information of each of the video frames in the video frame group based on the pre-extraction features of all video frames in the video frame group. Therefore, by extracting the pre-extraction features of the respective video frames through a pre-extracting operation before extracting the reference information, it is beneficial to improve the enhancement effect of the model.

Optionally, in an example embodiment of the present disclosure, operation S302 includes: determining, for each of the video frames in the video frame group, a reference feature of the video frame based on the pre-extraction feature of the video frame and information of a video frame adjacent to the video frame; and determining the reference information of each of the video frames in the video frame group based on the reference features of all video frames in the video frame group.

Optionally, in an example embodiment of the present disclosure, the determining, for each of the video frames in the video frame group, a reference feature of the video frame based on the pre-extraction feature of the video frame and information of a video frame adjacent to the video frame, includes: determining, for a first video frame in the video frame group, a first reference feature of the first video frame based on the pre-extraction feature of the first video frame; determining, for each of the video frames in the video frame group except the first video frame, the first reference feature of the video frame based on the pre-extraction feature of the video frame and the first reference feature of the preceding video frame adjacent to the video frame; and determining the reference feature of each of the video frames in the video frame group based on the first reference features of all video frames in the video frame group. Of course, the present disclosure is not limited to this.

Optionally, in an example embodiment of the present disclosure, the determining, for each of the video frames in the video frame group except the first video frame, the first reference feature of the video frame based on the pre-extraction feature of the video frame and the first reference feature of the preceding video frame adjacent to the video frame includes: acquiring, for each of the video frames in the video frame group except the first video frame, the first reference feature of the preceding key frame of the video frame; and determining the first reference feature of the video frame based on the first reference feature of the preceding key frame of the video frame, the pre-extraction feature of the video frame and the first reference feature of the preceding video frame adjacent to the video frame. Of course, the present disclosure is not limited to this.

Optionally, in an example embodiment of the present disclosure, the determining the reference feature of each of the video frames in the video frame group based on the first reference features of all video frames in the video frame group includes: determining, for the last video frame in the video frame group, a second reference feature of the last video frame based on the first reference feature of the last video frame; determining, for each of the video frames in the video frame group except the last video frame, the second reference feature of the video frame based on the first reference feature of the video frame and the second reference feature of the subsequent video frame adjacent to the video frame, and determining a reference feature of each of the video frames in the video frame group based on the second reference features of all video frames in the video frame group. Of course, the present disclosure is not limited to this.

Optionally, in an example embodiment of the present disclosure, the determining, for each of the video frames in the video frame group except the last video frame, the second reference feature of the video frame based on the first reference feature of the video frame and the second reference feature of the subsequent video frame adjacent to the video frame includes: acquiring, for each of the video frames in the video frame group except the last video frame, the second reference feature of the subsequent key frame of the video frame; and determining the second reference feature of the video frame based on the second reference feature of the subsequent key frame of the video frame, the first reference feature of the video frame and the second reference feature of the subsequent video frame adjacent to the video frame. Of course, the present disclosure is not limited to this.

In an example embodiment of the present disclosure, operation S302 may be implemented by using a pre-extraction module and a temporal-spatial feature extraction module. The pre-extraction module and the temporal-spatial feature extraction module commonly constitute a reference information generation module, which is a three-dimensional-convolution-based bi-directional propagation neural network model. The model can extract the reference information suitable for respective video frames from the information of all video frames in each video frame group. In which “three-dimensional-convolution” means that three-dimensional convolution kernels are used to process each video frame group. Compared with traditional two-dimensional convolution operation (i.e., in which only two-dimensional convolution kernels are used to process video data), the three-dimensional convolution operation can extract information from a plurality of video frames, so it can extract features in consecutive video frames from the spatial and temporal dimensions to provide more information for the quality enhancement of each video frame. And “bi-directional propagation” means that the neural network, when determining the reference information of each of the video frames, considers both video frames that are preceding to this video frame in chronological order and video frames that are subsequent to this video frame in chronological order. Therefore, the bi-directional propagation neural network can extract more context information, thereby realizing quality enhancement of respective video frames. It is exactly because of the three-dimensional-convolution-based bi-directional propagation architecture of the neural network that it can only include a small number of neurons and can determine the reference information of each of video frames without complicated calculation. Compared with the complex network model in traditional quality enhancement scheme, the embodiments of the present disclosure are easier to be deployed. The three-dimensional-convolution-based bi-directional propagation neural network is further illustrated with reference to FIG. 4 to FIG. 6, and it should be understood by those skilled in the art that the present disclosure is not limited to this.

In addition, in some embodiments of the present disclosure, since the reference information generated in operation S302 is fused with the information of all video frames in the video frame group, it is necessary to filter the reference information to remove the interference by the redundant information in the reference information on the quality enhancement of video frames. Of course, the present disclosure is not limited to this.

Next, in operation S303, determining an enhanced video frame for the at least one video frame based on the reference information of the at least one video frame in the video frame group and the information of the at least one video frame.

Since reference information for one or more video frames has been acquired in operation S302, it is essentially a detailed texture information relative to the original data of the video frame, which indicates information on how to adjust one video frame in the video frame group based on other video frames in the video frame group. Therefore, the enhancement of one or more video frames can be realized by fusing the reference information of one or more video frames in the video frame group and the information of one or more video frames themselves.

Optionally, in some embodiments of the present disclosure, an enhanced video frame for each of the video frames may be determined based on the reference information of each of the video frames in the video frame group and the information of each of the video frames.

Optionally, in some embodiments of the present disclosure, operation S303 includes: determining image enhancement information of a single channel of each of the video frames in the video frame group based on reference information of each of the video frames in the video frame group; and superimposing the image enhancement information of the single channel of each of the video frames in the video frame group with the pre-extraction feature of the video frame to acquire an enhanced video frame for each of the video frames in the video frame group.

In an example embodiment of the present disclosure, operation S303 may be implemented by using an information fusion module. The information fusion module is a single-layer two-dimensional convolutional neural network, which compresses the reference information of each of the video frames from a multi-channel image to a single-channel image, thereby realizing the fusion of the information associated with a plurality of video frames in the reference information. Then, the single-channel image is superimposed with the original image of the video frame, thus resulting in the enhanced video frame of each of the video frames. As an example, the information fusion module can be further illustrated later with reference to FIG. 4 to FIG. 6, which will not be detailed herein by the present disclosure. Of course, it should be understood by those skilled in the art that the present disclosure is not limited thereto.

Optionally, the method 30 according to the embodiment of the present disclosure may further include operation S304. Optionally, in operation S304, displaying the enhanced video frame for the one or more video frames in the video data. Of course, the present disclosure is not limited to this.

Therefore, the method 30 according to the embodiment of the present disclosure makes full use of the characteristics of the video data processed by the video coding technology to enhance the quality of the decoded video data, so as to, with a low calculational burden, significantly enhance the texture details of the decoded video data and reduce the artifacts and distortions in the decoded video data, thereby significantly enhancing the quality of the decoded video data. The embodiments of the present disclosure can also be deployed in a display terminal in a lightweight manner, providing a better use experience for the users of ultra-high definition display terminal.

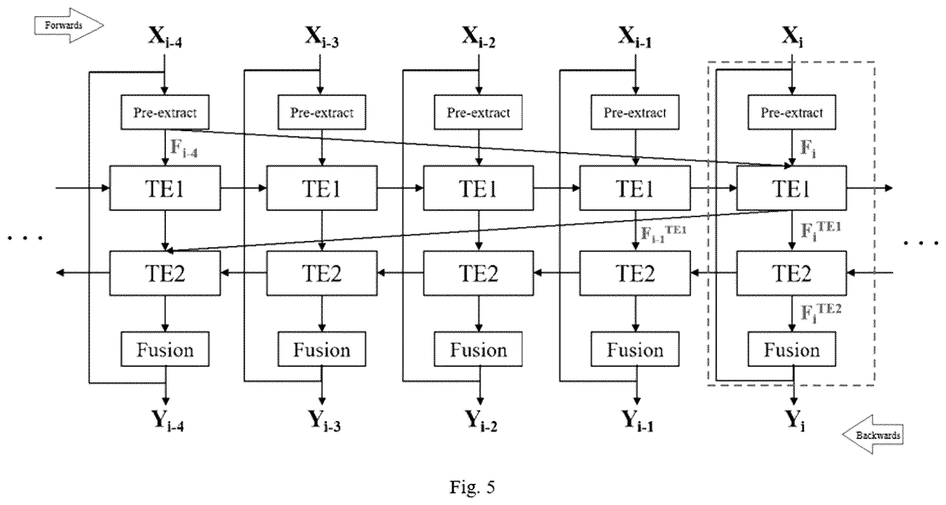

FIG. 4 is a schematic diagram illustrating an apparatus 400 for processing video data according to an embodiment of the present disclosure. FIG. 5 is yet another schematic diagram illustrating the apparatus 400 according to an embodiment of the present disclosure, which illustrates some of the components in the apparatus 400. The apparatus 400 described with reference to FIG. 4 to FIG. 5 may be configured to perform the method 30 detailed above.

The apparatus 400 may also be referred to herein as a model for processing video data. In addition, the apparatus 400 may include more or less modules, which is not limited by the present disclosure.

The apparatus 400 optionally includes a division module, a reference information generation module and an information fusion module. The division module is configured to divide the plurality of video frames in chronological order to generate at least one video frame groups. The reference information generation module is configured to determine reference information of each of video frames in each video frame group of the at least one video frame groups based on information of all video frames in the video frame group. The information fusion module is configured to determine an enhanced video frame for each of the video frames based on the reference information of each of the video frames in the video frame group and the information of each of the video frames. Optionally, the apparatus 400 further includes a display module configured to display the enhanced video frame of each of the video frames in the video data.

For example, the division module may be used to perform the above-described operation S301. For example, it is assumed that the decoded video data includes N video frames (reconstructed frames), which N frames are divided in groups of k frames into N/k video frame groups in chronological order. Optionally, k is equal to 24. The size of the i-th video frame Xᵢ in each video frame group is B×C×H×W, in which H is the amount of pixels of the video frame on the shorter side (i.e., H indicates the height of the video frame), W is the amount of pixels of the video frame on the longer side (i.e., W indicates the width of the video frame), B is the batch size and B is a fixed value. C is the number of channels of the video frame, since in this case the video frame Xᵢ is the single-channel image, C is equal to 1. The illustration below is made by taking the enhanced video frame for determining the video frame Xᵢ as an example, and it should be understood by those skilled in the art that the present disclosure is not limited to this.

For example, the reference information generation module may be used to perform the above-described operation S302. The reference information generation module has been briefly introduced before. Next, a specific implementation is described with reference to FIG. 5.

As shown in FIG. 5, the example reference information generation module includes at least one pre-extraction module (shown as Pre-extract) and at least one temporal-spatial feature extraction module (shown as TE). Of course, the present disclosure is not limited to this.

In a specific example, any pre-extraction module may be configured to determine the pre-extraction feature of each of the video frames in each video frame group of the at least one video frame groups based on the information of all video frames in the video frame group, to acquire the pre-extraction features of all video frames in the video frame group. Of course, the present disclosure is not limited to this.

Exemplarily, the pre-extraction module is composed of a single-layer two-dimensional convolutional neural network layer, which may convolute the video frame Xᵢ by using a convolution kernel with a size of 3*3, expand the original single-channel image C into C′ channels, and interact among the C′ channels, thus resulting in the pre-extraction feature Fᵢ of the video frame Xᵢ. The size of the pre-extraction feature Fᵢ of the video frame Xᵢ is B×C′×H×W, in which C′ is greater than or equal to C and can be 32, but the present disclosure is not limited to this. In some embodiments, the pre-extraction module preliminarily extracts the intra feature of the video frame Xᵢ without extracting the inter feature of several consecutive video frames. According to the experiment, it is beneficial to improve the enhancement effect of the model by performing a pre-extracting operation respectively on the respective video frames in the initial stage of the model. Of course, the pre-extraction module can also be replaced by other neural network structures, such as fully connected layer or three-dimensional convolutional neural network layer or the like, which is not limited by the present disclosure.

In a specific example, any temporal-spatial feature extraction module may be configured to: determine, for a corresponding video frame in the video frame group, the reference feature of the video frame based on the pre-extraction feature of the video frame and the information of the video frames adjacent to the video frame. The reference feature of the video frame includes, but is not limited to, the first reference feature and the second reference feature described later, as well as a reference feature generated based on the first reference feature and the second reference feature. Of course, the present disclosure is not limited to this.

Exemplarily, a plurality of pre-extraction modules can constitute a bi-directional propagation architecture as shown in FIG. 5, which includes a forward propagation layer and a backward propagation layer. In FIG. 5, the forward propagation layer is connected with a left-to-right arrow “→” (whose propagation direction is along the direction indicated by the arrow “forward” in FIG. 5), and the backward propagation layer is connected with a right-to-left arrow “←” (whose propagation direction is along the direction indicated by the arrow “backward” in FIG. 5). The information corresponding to respective video frames is transferred along the directions of the arrows, so that each of the video frames is correspondingly know the information of all other video frames in the video frame group.

Optionally, the forward propagation layer may be configured to: determine, for the first video frame in the video frame group, the first reference feature of the first video frame based on the pre-extraction feature of the first video frame; and determine, for each of the video frames in the video frame group except the first video frame, the first reference feature of the video frame based on the pre-extraction feature of the video frame and the first reference feature of the preceding video frame adjacent to the video frame. Optionally, the determine, for each of the video frames in the video frame group except the first video frame, the first reference feature of the video frame based on the pre-extraction feature of the video frame and the first reference feature of the preceding video frame adjacent to the video frame includes: acquire, for each of the video frames in the video frame group except the first video frame, the first reference feature of the preceding key frame of the video frame; and determine the first reference feature of the video frame based on the first reference feature of the preceding key frame of the video frame, the pre-extraction feature of the video frame and the first reference feature of the preceding video frame adjacent to the video frame. Of course, the present disclosure is not limited to this.

For example, the input of each of the temporal-spatial feature extraction modules in the forward propagation layer includes an output of the preceding adjacent temporal-spatial feature extraction module, and the pre-extraction feature of the current video frame (also referred to as the current frame, such as video frame Xᵢ). The output of each of the temporal-spatial feature extraction modules in the forward propagation layer includes the first reference feature, which is to be input to the subsequent adjacent temporal-spatial feature extraction module, and the corresponding temporal-spatial feature extraction modules in the backward propagation layer. For example, as shown in FIG. 5, in the forward propagation layer, the input of the temporal-spatial feature extraction module TE1ᵢ corresponding to the video frame Xᵢ includes the pre-extraction feature of the video frame Xᵢ and the output of the temporal-spatial feature extraction module TE1ᵢ corresponding to the video frame Xᵢ₋₁. The output of the temporal-spatial feature extraction module TE1ᵢ corresponding to the video frame Xᵢ is shown as the first reference feature Fi^{TE1} of the video frame Xᵢ, which is output to the temporal-spatial feature extraction module TE1ᵢ₊₁ corresponding to the video frame Xᵢ₊₁ in the forward propagation layer, and to the temporal-spatial feature extraction module TE2; corresponding to the video frame Xᵢ in the backward propagation layer.

In addition, in some examples, the input of all or part of the temporal-spatial feature extraction modules also includes the pre-extraction feature of the preceding key frame. For example, as shown in FIG. 5, it is assumed that the (i−4)th frame is a key frame, then the input of the temporal-spatial feature extraction module TE1ᵢ corresponding to the video frame Xᵢ also includes the pre-extraction feature Fᵢ₋₄ of the (i−4)th frame. The first reference feature Fi^{TE1} output by all or part of the temporal-spatial feature extraction modules will also be output to the temporal-spatial feature extraction module corresponding to the preceding key frame in the backward propagation layer. It is worth noting that the said key frame mentioned here may be any video frame with high image quality, but does not necessarily refer to an I frame. For example, as shown in FIG. 5, it is assumed that the (i−4)th frame is a key frame, then the first reference feature Fi^{TE1} of the video frame Xᵢ is also input to the temporal-spatial feature extraction module TE2ᵢ₋₄ corresponding to the (i−4)th frame in the backward propagation layer. In addition, the input of the temporal-spatial feature extraction module TE₀ corresponding to the first video frame in the video frame group may only include the pre-extraction feature F₀ of the video frame X₀. After being processed by the forward propagation layer for one time, each of the video frames in the video frame group will know the information of all the preceding video frames, thereby realizing the video enhancement processing based on the plurality of preceding video frames. It should be understood by those skilled in the art that FIG. 5 is only an example, which is not limited by the present disclosure.

Optionally, the backward propagation layer may be configured to: determine, for the last video frame in the video frame group, the second reference feature of the last video frame based on the first reference feature of the last video frame; determine, for each of the video frames in the video frame group except the last video frame, the second reference feature of the video frame based on the first reference feature of the video frame and the second reference feature of the subsequent video frame adjacent to the video frame, and determine the reference feature of each of the video frames in the video frame group based on the second reference features of all video frames in the video frame group. Optionally, the determining, for each of the video frames in the video frame group except the last video frame, the second reference feature of the video frame based on the first reference feature of the video frame and the second reference feature of the subsequent video frame adjacent to the video frame includes: acquire, for each of the video frames in the video frame group except the last video frame, the first reference feature of the subsequent key frame of the video frame; and determine the second reference feature of the video frame based on the first reference feature of the subsequent key frame of the video frame, the first reference feature of the video frame and the second reference feature of the subsequent video frame adjacent to the video frame. Of course, the present disclosure is not limited to this.

The input of each of the temporal-spatial feature extraction modules in the backward propagation layer includes an output of the subsequent adjacent temporal-spatial feature extraction module, and the first reference feature of the current video frame (also referred to as the current frame, such as video frame Xᵢ). The output of each of the temporal-spatial feature extraction modules in the backward propagation layer includes a second reference feature, which is to be input to a preceding adjacent temporal-spatial feature extraction module and a corresponding sub-module in the information fusion module. For example, as shown in FIG. 5, in the backward propagation layer, the input of the temporal-spatial feature extraction module TE2; corresponding to the video frame Xᵢ includes the first reference feature Fi^{TE1} of the video frame Xᵢ and the output of the temporal-spatial feature extraction module TE2ᵢ₊₁ corresponding to the video frame Xᵢ₊₁. The output of the temporal-spatial feature extraction module TE2; corresponding to the video frame Xᵢ is shown as the second reference feature Fi^{TE2} of the video frame Xᵢ, which is output to the temporal-spatial feature extraction module TE2ᵢ₋₁ corresponding to the video frame Xᵢ₋₁ in the backward propagation layer and the corresponding sub-module Fusionᵢ in the information fusion module.

In addition, in some examples, the input of all or part of the temporal-spatial feature extraction modules also includes the pre-extraction feature of the subsequent key frame. It is worth noting that the said key frame here may be any video frame with high image quality, but does not necessarily refer to an I frame. For example, as shown in FIG. 5, it is assumed that the i-th frame is a key frame, then the input of the temporal-spatial feature extraction module TE2; corresponding to the video frame Xᵢ₋₄ also includes the first reference feature Fi^{TE1} of the i-th frame. In addition, the input of the temporal-spatial feature extraction module TEK corresponding to the last video frame in the video frame group (which includes k video frames) only includes the first reference feature Fₖ^{TE1} of the video frame Xₖ. After being processed by the backward propagation layer, each of the video frames in the video frame group will know the information of its subsequent video frame, thereby realizing the video enhancement processing based on a plurality of subsequent video frames. It should be understood by those skilled in the art that FIG. 5 is only an example, which is not limited by the present disclosure.

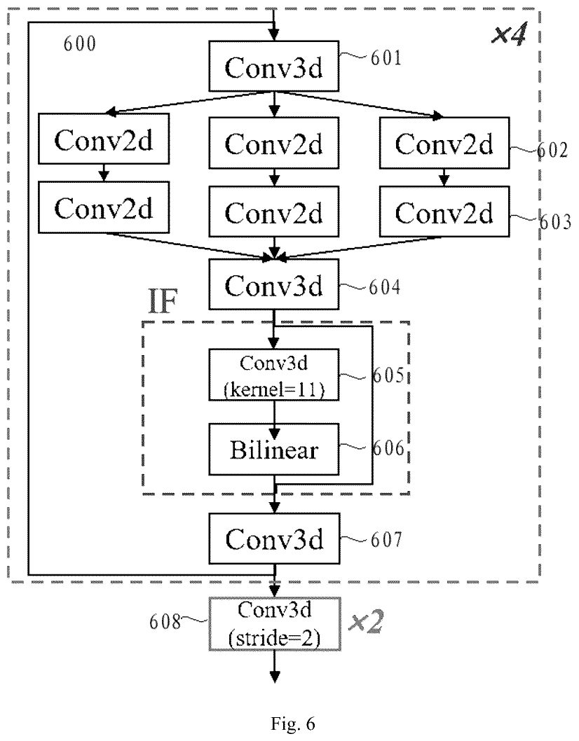

The respective temporal-spatial feature extraction modules may be based on a three-dimensional convolutional network to reduce the number of parameters in the neural network, so that the neural network model is easy to be deployed. The respective temporal-spatial feature extraction modules may further include a temporal-spatial information filter module to remove the interference by redundant information in the reference feature on the quality enhancement of the video frame. The optional implementation details of the respective temporal-spatial feature extraction modules are further illustrated with reference to FIG. 6, which is detailed here by the present disclosure.

Therefore, the second reference features corresponding to respective video frames has been acquired, which may be directly taken as the reference information of respective video frames. The second reference feature may also be further processed (such as convolution processing, linearly transformed, up-sampling, down-sampling, etc.) to acquire the reference information, which is not limited by the present disclosure.

For example, the information Fusion module (shown as Fusion in FIG. 5) may be used to perform the above-described operation S303. The information fusion module may be configured to: determine image enhancement information of a single channel of each of the video frames in the video frame group based on reference information of each of the video frames in the video frame group; and superimpose the image enhancement information of the single channel of each of the video frames in the video frame group with the pre-extraction feature of the video frame to acquire the enhanced video frame for each of the video frames in the video frame group.

For example, the information fusion module may include at least one information fusion sub-module. Each information fusion sub-module corresponds to a video frame. The information fusion sub-module Fusionᵢ corresponding to the video frame Xᵢ is composed of a single-layer two-dimensional convolutional neural network layer. The information fusion sub-module Fusionᵢ compresses the original C′-channel feature (i.e., the second reference feature Fi^{TE2}) into a single-channel image, and interacts between channels to superimpose the pre-extraction feature Fᵢ corresponding to the video frame Xᵢ, thus resulting in an enhanced video frame. The Fusion module respectively fuses features corresponding respective frames to output several consecutive enhanced video frames, such as the enhanced video frames of the 24 video frames in the video frame group.

Therefore, the apparatus 400 according to the embodiment of the present disclosure makes full use of the characteristics of the video data processed by the video coding technology to enhance the quality of the decoded video data, so as to significantly enhance the texture details of the decoded video data and reduce the artifacts and distortions in the decoded video data, thereby significantly enhancing the quality of the decoded video data. The apparatus 400 according to the embodiment of the present disclosure significantly reduces the amount of parameters through a convolutional-network-based bi-directional propagation architecture, thereby achieving a substantial reduction in the amount of calculation. The apparatus 400 according to the embodiment of the present disclosure can also be deployed in a display terminal in a lightweight manner, providing a better use experience for the users of ultra-high definition display terminal.

FIG. 6 is a schematic diagram illustrating a temporal-spatial feature extraction module according to an embodiment of the present disclosure.

As described above, the input of each of the temporal-spatial feature extraction modules in the forward propagation layer includes the first reference feature of the preceding key frame of the video frame, the pre-extraction feature of the video frame and the first reference feature of the preceding video frame adjacent to the video frame. Each of the temporal-spatial feature extraction modules in the forward propagation layer may be configured to: perform three-dimensional convolution processing and two-dimensional convolution processing on the first reference feature of the preceding key frame of the video frame, the pre-extraction feature of the video frame and the first reference feature of the preceding video frame adjacent to the video frame, to obtain a fusion feature that fuses the first reference feature of the preceding key frame of the video frame, the pre-extraction feature of the video frame and the first reference feature of the preceding video frame adjacent to the video frame; and removing redundant information from the fusion feature to determine the first reference feature of the video frame. Optionally, three-dimensional convolution processing and two-dimensional convolution processing are performed on the first reference feature of the preceding key frame of the video frame, the pre-extraction feature of the video frame and the first reference feature of the preceding video frame adjacent to the video frame, to obtain a fusion feature that fuses the first reference feature of the preceding key frame of the video frame, the pre-extraction feature of the video frame and the first reference feature of the preceding video frame adjacent to the video frame; and redundant information is removed from the fusion feature to determine the first reference feature of the video frame. Of course, the present disclosure is not limited to this.

As shown in FIG. 6, each of the temporal-spatial feature extraction modules may include at least one three-dimensional convolution layer, at least one two-dimensional convolution layer, a linear layer, etc., which is not limited by the present disclosure. It is assumed that the temporal-spatial feature extraction module shown in FIG. 6 is the temporal-spatial feature extraction module TE1ᵢ corresponding to the video frame Xᵢ in the forward propagation layer.

As shown in FIG. 5, the input of the temporal-spatial feature extraction module TE1ᵢ includes the output Fᵢ₋₁^{TE1} of the temporal-spatial feature extraction module TE1ᵢ₋₁, the output Fᵢ of the ith pre-extraction module, and the output Fᵢ₋₄ of the pre-extraction module corresponding to the key frame ((i−4)th frame). These three vectors are combined in the T dimension to commonly constitute a feature vector Fⁱⁿᵢ with a size of B×C′×T×H×W, where T=3.

The first three-dimensional convolution layer 601 of the temporal-spatial feature extraction module TE1ᵢ dimensionally reduces the feature vector Fin; in the C dimension. The convolution kernel of the first three-dimensional convolution layer 601 is of a size of 3*3*3, with a step size of 1 in the H dimension, a step size of 1 in the W dimension and a step size of 2 in the C dimension. Therefore, after being processed by the convolution layer 601, the feature F¹ᵢ halved in the C dimension will be obtained. The size of the feature F¹ᵢ is B×(C//2)×T×H×W, where (C//2) means dividing C by a divisor of 2. The process of processing the feature vector Fⁱⁿᵢ by the first three-dimensional convolution layer 601 can be expressed by formula (1).

$${F}_{i}^{1} = D ( {F}_{i}^{i n} ) \qquad ( 1 )$$

where D(·) means dimensionally reducing the feature vector Fⁱⁿᵢ in the C dimension. Fᵢ¹ is the output of the first three-dimensional convolution layer 601.

Then, the temporal-spatial feature extraction module TE1ᵢ decomposes F¹ᵢ in the T dimension into three features

$${F}_{i}^{1 , 1} , {F}_{i}^{1 , 2} , {F}_{i}^{1 , 3}$$

with a size of B×(C//2)×H×W.

$${F}_{i}^{1 , 1} , {F}_{i}^{1 , 2} , {F}_{i}^{1 , 3}$$

pass through three first two-dimensional convolution layers 602 and three second two-dimensional convolution layers 603 of the temporal-spatial feature extraction module TE1ᵢ, respectively. The first two-dimensional convolution layers 602 and the second two-dimensional convolution layers 603 are connected in series, whereas the three first two-dimensional convolution layers 602 are connected in parallel and the three second two-dimensional convolution layers 603 are connected in parallel. The process of decomposing F¹ᵢ in the T dimension into three features

$${F}_{i}^{1 , 1} , {F}_{i}^{1 , 2} , {F}_{i}^{1 , 3}$$

with a size of B×(C//2)×H×W can be expressed by formula (2).

$${F}_{i}^{1 , 1} , {F}_{i}^{1 , 2} , {F}_{i}^{1 , 3} = S ( {F}_{i}^{1} ) \qquad ( 2 )$$

where S(·) represents an operation for decomposing F¹ᵢ in the T dimension.

The three first two-dimensional convolution layers 602 and three second two-dimensional convolution layers 603 of the temporal-spatial feature extraction module TE1ᵢ perform an intra feature extracting operation on

$${F}_{i}^{1 , 1} , {F}_{i}^{1 , 2} , {F}_{i}^{1 , 3} ,$$

respectively, to obtain three features

$${F}_{i}^{2 , 1} , {F}_{i}^{2 , 2} , {F}_{i}^{2 , 3} .$$

This process can be expressed by formulas (3)-(5).

$${F}_{i}^{2 , 1} = {I}_{2} ( {I}_{1} ( {F}_{i}^{1 , 1} ) ) \qquad ( 3 )$$

$${F}_{i}^{2 , 2} = {I}_{2} ( {I}_{1} ( {F}_{i}^{1 , 2} ) ) \qquad ( 4 )$$

$${F}_{i}^{2 , 3} = {I}_{2} ( {I}_{1} ( {F}_{i}^{1 , 3} ) ) \qquad ( 5 )$$

where I₁(·) and I₂(·) represents two intra feature extracting operations.

Next, the temporal-spatial feature extraction module TE1ᵢ merges the three features

$${F}_{i}^{2 , 1} , {F}_{i}^{2 , 2} , {F}_{i}^{2 , 3}$$

in the T dimension, to obtain a feature Fᵢ² with a size of B×(C//2)×3×H×W. This process can be expressed by formula (6).

$${F}_{i}^{2} = C ( {F}_{i}^{2 , 1} , {F}_{i}^{2 , 2} , {F}_{i}^{2 , 3} ) \qquad ( 6 )$$

where C(·) represents an operation for merging a plurality of features in the T dimension.

Next, the features

$${F}_{i}^{2}$$

is input to a second three-dimensional convolution layer 604. The second three-dimensional convolution layer 604 of the temporal-spatial feature extraction module TE1ᵢ uses a three-dimensional convolution kernel to inter-frame fusion of the feature

$${F}_{i}^{2} ,$$

to obtain a feature

$${F}_{i}^{3}$$

with a size of B×(C′//2)×T×H×W, where T=3. This process can be expressed by formula (7).

$${F}_{i}^{3} = {I}_{n} ( {F}_{i}^{2} ) \qquad ( 7 )$$

where Iₙ(·) represents an operation for inter-frame fusion of the feature

$${F}_{i}^{2} .$$

Next, the feature

$${F}_{i}^{3}$$

is input to the temporal-spatial information filter module IF, which includes a third three-dimensional convolution layer 605 and a linear layer 606. Since the forward propagation layer propagates information within up to 24 frames, various embodiments of the present disclosure can use the temporal-spatial information filter module IF to minimize the accumulation of interference information. The third three-dimensional convolution layer 605 performs feature down-sampling with a large receptive field by using 1-layer group convolution with a three-dimensional convolution kernel with a size of 3*11*11 (Y*H*W), with the step size possibly being set to 4, thus resulting in a feature

$${F}_{i}^{K} .$$

Therefore, a function of information filtering is completed. Since the video frame (reconstructed frame) contains so many compression artifacts and blurs, such information are not conducive to the enhancement process. By down-sampling with a large convolution kernel, the interference information can be adaptively filtered out. This process can be expressed by Formula (8).

$${F}_{i}^{K} = K ( {F}_{i}^{3} ) \qquad ( 8 )$$

where K(·) represents a feature down-sampling operation with a large receptive field on the feature. The temporal-spatial information filter module IF then reconstructs the textures by using the linear layer 606. The linear layer 606 uses a Bilinear function to up-sample the feature

$${F}_{i}^{K}$$

by 4 times and then superimpose it with the feature F³ᵢ to obtain a feature F⁴ᵢ with a size of B×(C//2)×3×H×W. This process can be expressed by Formula (9). Using a Bilinear function to reconstruct the textures can instead restore clearer details than the original blur area.

$${F}_{i}^{4} = B ( {F}_{i}^{K} ) + {F}_{i}^{3} \qquad ( 9 )$$

Then, a fourth three-dimensional convolution layer 607 of the temporal-spatial feature extraction module TE1ᵢ uses a 1-layer three-dimensional convolution neural network to dimensionally augment the input feature, to acquire a feature F⁵ᵢ with a size of B×C×3×H×W. This process can be expressed by Formula (10).

$${F}_{i}^{5} = U ( {F}_{i}^{4} ) \qquad ( 10 )$$

where U(·) represents an operation for dimensionally augmenting in the C dimension.

The above process can be repeated for many times, resulting in a feature

$${F}_{i}^{6}$$

with a size of B×C×3×H×W can be obtained. In general, the more times the process is repeated, the better the enhancement capability of the model is. However, due to the limitation of the number of parameters and the amount of calculation in actual use, this process can be repeated 4 times.

Finally, down-sampling in time domain (i.e., down-sampling in the T dimension) is performed on

$${F}_{i}^{6}$$

by using a fifth three-dimensional convolution layer 608. The fifth three-dimensional convolution layer 608 is a two-layer three-dimensional convolution neural network, which compresses the feature

$${F}_{i}^{6}$$

into a feature dimension corresponding to a single frame, and superimpose it with

$${F}_{i}^{i n} ,$$

to acquire a feature

$${F}_{i}^{T E 1}$$

with a size of B×C×H×W. This process can be expressed by Formula (11).

$${F}_{i}^{T E 1} = {D}_{2}^{T} ( {D}_{1}^{T} ( {F}_{i}^{6} ) ) + {F}_{i}^{i n} \qquad ( 11 )$$

where

$${D}_{2}^{T} ( \cdot ) and {D}_{1}^{T}$$

represents two time-domain down-sampling operations.

Therefore, the temporal-spatial feature extraction module realizes, with less number of parameters, the fusion of information of multiple frames and the removal of redundant information, thereby, with a low amount of calculation, significantly enhancing the texture details of the decoded video data and reducing the artifacts and distortions in the decoded video data, thus significantly enhancing the quality of the decoded video data.

Similarly, the respective temporal-spatial feature extraction modules in the backward propagation layer may also have a similar architecture. For example, the input of the respective temporal-spatial feature extraction modules in the backward propagation layer includes: a first reference feature of the subsequent key frame of the video frame, a first reference feature of the video frame and a second reference feature of the subsequent video frame adjacent to the video frame. Therefore, the respective temporal-spatial feature extraction modules in the backward propagation layer may also be configured to: perform three-dimensional convolution processing and two-dimensional convolution processing on the first reference feature of the subsequent key frame of the video frame, the first reference feature of the video frame and the second reference feature of the subsequent video frame adjacent to the video frame, to acquire a fusion feature that fuses the first reference feature of the subsequent key frame, the first reference feature of the video frame and the second reference feature of the subsequent video frame adjacent to the video frame; and remove redundant information from the fusion feature to determine a second reference feature of the video frame. The removing redundant information from the fusion feature to determine the second reference feature of the video frame includes: down-sampling the fusion feature by using a group convolution operation to acquire the fusion feature with redundant information removed; and performing bilinear mapping processing on the fusion feature with redundant information removed to determine the second reference feature of the video frame. Of course, the present disclosure is not limited to this.

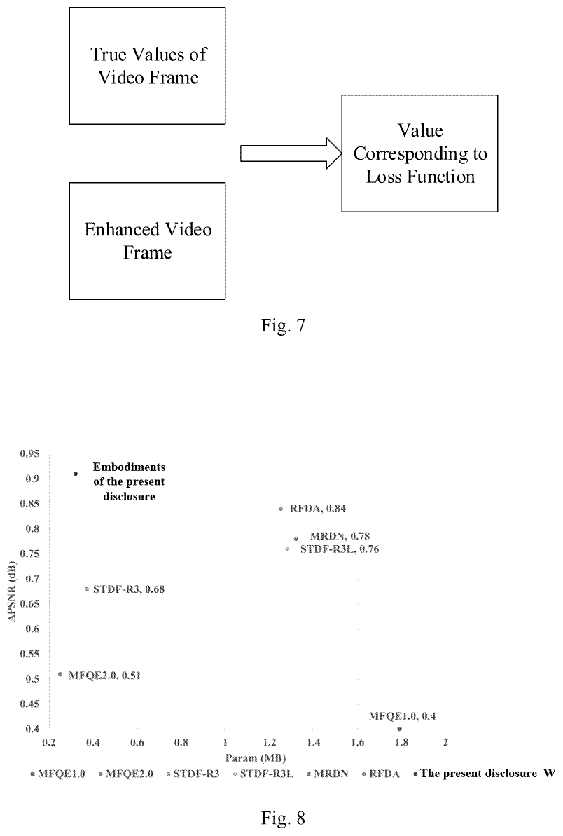

Next, the training methods of the above-described respective neural network models are further described with reference to FIG. 7 and FIG. 8. FIG. 7 is a schematic diagram illustrating an example for training a model for processing video data according to an embodiment of the present disclosure. FIG. 8 is a schematic diagram illustrating an example for a test effect of a scheme according to an embodiment of the present disclosure.

Optionally, the method 70 of training the apparatus 400 may be briefly described as: acquiring a true value of a video frame in sample video data; encoding and decoding the video frame in the sample video data to acquire a reconstructed frame corresponding to the video frame in the sample video data; predicting an enhanced video frame for the reconstructed frame by using the apparatus under training; calculating a value corresponding to a loss function based on the enhanced video frame and the true value of the video frame; and adjusting parameters for respective convolution kernels and respective neurons in the apparatus based on the value corresponding to the loss function, so that the value corresponding to the loss function converges. Of course, the present disclosure is not limited to this.

As an example, the MFQE 2.0 data set can be selected as the true values of the sample video data. The MFQE 2.0 data set contains 126 videos with a considerable range of resolution: SIF (352×240), CIF (352×288), NTSC (720×486), 4CIF (704×576), 240p (416×240), 360p (640×360), 480p (832×480), 720p (1280×720), 1080p (1920×1080) and WQXGA (2560×1600). In the process of testing various embodiments of the present disclosure, 106 of the videos were adopted for training and the remaining 10 videos were adopted for verification. The test set adopts 18 standard test sequences proposed by JCT-VC. All the sequences are encoded with LDP configuration of HM 16.20 under four different quantization parameters (QPs) of 22, 27, 32 and 37.

As an example, an example of the training apparatus 400 is briefly introduced below. This process can be briefly described as follows.

Firstly, the true values of the sample video data are encoded and decoded according to the video coding standard, to obtain the sample video data to be predicted including a plurality of sample video frames. Then, the apparatus 400 under training is used to predict the enhanced video frames of the respective sample video frames of the plurality of sample video frames. Then, based on the enhanced video frames of the respective sample video frames and the true values of the plurality of sample video frames, a Charbonnier loss is calculated, and the parameters of the respective convolution kernels and the respective neurons in the apparatus 400 are adjusted based on the Charbonnier loss, so as to make the Charbonnier loss converge.

In the process of testing various embodiments of the present disclosure, 150,000 iterations were conducted. For the first 50,000 iterations, the learning rate was set to 10-3. The rate for the remaining 100,000 iterations is adjusted to 10⁻⁴. The Batch size of the training is specifically set to 24. 13 frames are input for training each time, and the size is randomly cropped into 128*128. An Adam optimizer is used, where β¹=0.9 and β²=0.99.

During the training, the size of the respective video frames is B=24, C=32, T=13, H=128 and W=128. During the testing and reasoning, the size of the respective video frames is B=1, C=32, T=40, H=1080, and W=1920. In which H and W depend on the size of the video to be inferred.

As shown in FIG. 8, after the testing, compared with the performance of other models, the apparatus 400 achieves a maximum improvement (0.91 dB) in peak signal-to-noise ratio with a minimum number of parameters. It embodies the advantages of the apparatus 400 over other methods.

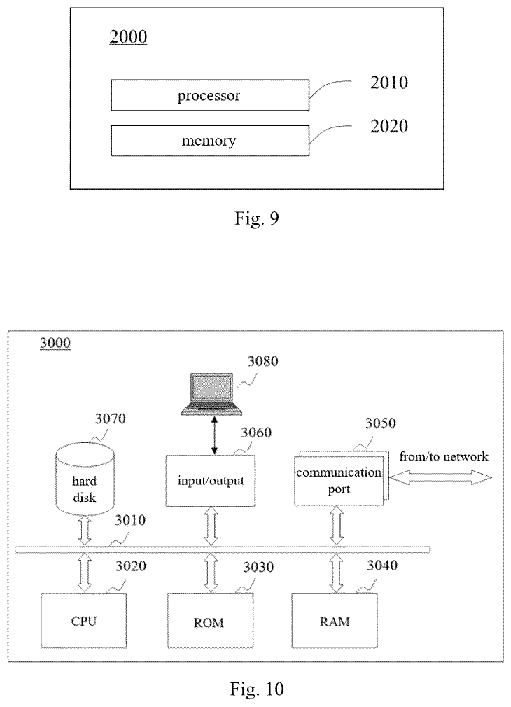

According to yet another aspect of the present disclosure, there is further provided an electronic device for implementing the method 30 according to the embodiment of the present disclosure or carrying the apparatus 400 according to the embodiment of the present disclosure. FIG. 9 illustrates a schematic diagram of an electronic device 2000 according to an embodiment of the present disclosure.

As shown in FIG. 9, the electronic device 2000 may include one or more processors 2010 and one or more memories 2020. Among other things, the memory 2020 stores computer-readable codes which, when executed by the one or more processors 2010, can perform the method as described above.

The processor in the embodiments of the present disclosure may be an integrated circuit chip with signal processing capability. The processor may be a general processor, a digital signal processor (DSP), an application specific integrated circuit (ASIC), a field programmable gate array (FPGA) or other programmable logic device, discrete gate or transistor logic device, and discrete hardware component. Various methods, operations and logic blocks disclosed in the embodiments of the present disclosure can be implemented or executed. The general processor can be a microprocessor or can be any conventional processor, and can be of X86 architecture or ARM architecture.

In general, various example embodiments of the present disclosure can be implemented in hardware, or dedicated circuits, software, firmware, logics, or any combination thereof. Certain aspects can be implemented in hardware, whereas other aspects can be implemented in firmware or software that may be executed by a controller, microprocessor or other computing device. When various aspects of the embodiments of the present disclosure are illustrated or described as block diagrams, flowcharts, or using some other graphical representation, it will be understood that the blocks, apparatuses, systems, techniques, or methods described herein can be implemented in hardware, software, firmware, special-purpose circuits or logics, general-purpose hardware or controllers or other computing devices, or some combination thereof, as non-limiting examples.

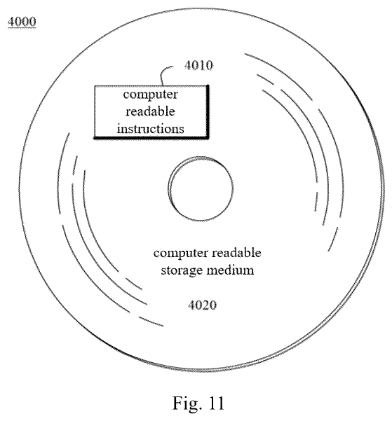

For example, the method or apparatus according to the embodiments of the present disclosure can also be implemented by means of an architecture of a computing device 3000 shown in FIG. 10. As shown in FIG. 10, the computing device 3000 may include a bus 3010, one or more CPUs 3020, a read-only memory (ROM) 3030, a random access memory (RAM) 3040, a communication port 3050 connected to a network, an input/output component 3060, a hard disk 3070, and the like. A storage device in the computing device 3000, such as the ROM 3030 or the hard disk 3070, can store various data or files used for the processing and/or communication of the method provided by the present disclosure and program instructions executed by the CPU. The computing device 3000 may further include a user interface 3080. Of course, the architecture shown in FIG. 10 is only exemplary. When implementing different devices, one or more components in the computing device shown in FIG. 10 can be omitted according to actual needs.

According to yet another aspect of the present disclosure, there is further provided a computer-readable storage medium. FIG. 11 illustrates a schematic diagram 4000 of a storage medium according to the present disclosure.

As shown in FIG. 11, the computer storage medium 4020 stores computer-readable instructions 4010. When the computer-readable instructions 4010 are executed by a processor, the method according to the embodiments of the present disclosure described with reference to the above drawings may be performed. The computer-readable storage medium in the embodiments of the present disclosure may be a volatile memory or a nonvolatile memory, or may include both volatile and nonvolatile memories. The nonvolatile memory may be read-only memory (ROM), programmable read-only memory (PROM), erasable programmable read-only memory (EPROM), electrically erasable programmable read-only memory (EEPROM) or flash memory. The volatile memory may be a random access memory (RAM), which is used as an external cache. By way of illustration but not limitation, many forms of RAM are available, such as static random access memory (SRAM), dynamic random access memory (DRAM), synchronous dynamic random access memory (SDRAM), double data rate synchronous dynamic random access memory (DDRSDRAM), enhanced synchronous dynamic random access memory (ESDRAM), synchronous link dynamic random access memory (SLDRAM) and direct Rambus random access memory (DR RAM). It should be noted that the memories of the methods described herein are intended to include, but are not limited to, these and any other suitable types of memories. It should be noted that the memories of the methods described herein are intended to include, but are not limited to, these and any other suitable types of memories.

The embodiments of the present disclosure further provide a computer program product or computer program comprising computer instructions stored in a computer-readable storage medium. A processor of a computer device reads the computer instructions from the computer-readable storage medium, and the processor executes the computer instructions to cause the computer device performs the method according to the embodiments of the present disclosure.

It should be noted that the flowcharts and block diagrams in the drawings illustrate the possible implementable architectures, functions and operations of the systems, methods and computer program products according to various embodiments of the present disclosure. In this regard, each block in the flowcharts or block diagrams may represent a module, a program segment, or a part of code, which contains one or more executable instruction for implementing a specified logical function. It should also be noted that in some alternative implementations, the functions noted in the blocks may occur in a different order than that noted in the drawings. For example, two blocks shown in succession may actually be executed substantially in parallel, and they may sometimes be executed in a reverse order, depending on the functions involved. It should also be noted that each block in the block diagrams and/or flowcharts, and combinations of blocks in the block diagrams and/or flowcharts, can be implemented by a dedicated hardware-based system that performs specified functions or operations, or by a combination of dedicated hardware and computer instructions.

In general, various example embodiments of the present disclosure can be implemented in hardware, or dedicated circuits, software, firmware, logics, or any combination thereof. Certain aspects can be implemented in hardware, whereas other aspects can be implemented in firmware or software that may be executed by a controller, microprocessor or other computing device. When various aspects of the embodiments of the present disclosure are illustrated or described as block diagrams, flowcharts, or using some other graphical representation, it will be understood that the blocks, apparatuses, systems, techniques, or methods described herein can be implemented in hardware, software, firmware, special-purpose circuits or logics, general-purpose hardware or controllers or other computing devices, or some combination thereof, as non-limiting examples.

The exemplary embodiments of the present disclosure described in detail above are only illustrative, not restrictive. It should be understood by those skilled in the art that various modifications and combinations can be made to these embodiments or the features thereof without departing from the principles and spirit of the present disclosure, and such modifications should fall within the scope of the present disclosure.

What has been described above is only an exemplary implementation of the present disclosure, and is not used to limit the protection scope of the present disclosure, which is determined by the appended claims.

1. A method for processing video data, wherein the video data comprises a plurality of video frames, the method comprising:
dividing the plurality of video frames to generate at least one video frame groups;
determining reference information of at least one video frame in each video frame group of the at least one video frame groups based on information of all video frames in the video frame group; and
determining an enhanced video frame for the at least one video frame based on the reference information of the at least one video frame in the video frame group and the information of the at least one video frame.

2. The method of claim 1, wherein the dividing the plurality of video frames to generate at least one video frame groups comprises:
dividing the plurality of video frames in chronological order to generate at least one video frame groups.

3. The method of claim 1, wherein the determining reference information of at least one video frame in each video frame group of the at least one video frame groups based on information of all video frames in the video frame group comprises:
determining reference information of each video frame in the video frame group based on information of all video frames in each video frame group of the at least one video frame groups.

4. The method of claim 1, wherein the determining an enhanced video frame for the at least one video frame based on the reference information of the at least one video frame in the video frame group and the information of the at least one video frame comprises:
determining an enhanced video frame for each video frame based on the reference information of each video frame in the video frame group and the information of each video frame.

5. The method of claim 3, wherein the determining reference information of each video frame in the video frame group based on information of all video frames in each video frame group of the at least one video frame groups, comprises:
determining a pre-extraction feature of each video frame in the video frame group based on the information of all video frames in each video frame group of the at least one video frame groups, to acquire the pre-extraction features of all video frames in the video frame group; and
determining the reference information of each video frame in the video frame group based on the pre-extraction features of all video frames in the video frame group.

6. The method of claim 5, wherein determining reference information of each video frame in the video frame group based on information of all video frames in each video frame group of the at least one video frame groups, comprises:
determining, for each video frame in the video frame group, a reference feature of the video frame based on the pre-extraction feature of the video frame and information of a video frame adjacent to the video frame; and
determining the reference information of each of the video frames in the video frame group based on the reference features of all video frames in the video frame group.

7. The method of claim 5, wherein the determining, for each video frame in the video frame group, a reference feature of the video frame based on the pre-extraction feature of the video frame and information of a video frame adjacent to the video frame comprises:
determining, for a first video frame in the video frame group, a first reference feature of the first video frame based on the pre-extraction feature of the first video frame;
determining, for each video frame in the video frame group except the first video frame, the first reference feature of the video frame based on the pre-extraction feature of the video frame and the first reference feature of a preceding video frame adjacent to the video frame, and
determining the reference feature of each video frame in the video frame group based on the first reference features of all video frames in the video frame group.

8. The method of claim 6, wherein the determining, for each video frame in the video frame group except the first video frame, the first reference feature of the video frame based on the pre-extraction feature of the video frame and the first reference feature of a preceding video frame adjacent to the video frame comprises:
acquiring, for each video frame in the video frame group except the first video frame, the first reference feature of a preceding key frame of the video frame; and
determining the first reference feature of the video frame based on the first reference feature of the preceding key frame of the video frame, the pre-extraction feature of the video frame and the first reference feature of the preceding video frame adjacent to the video frame.

9. The method of claim 6, wherein the determining the reference feature of each video frame in the video frame group based on the first reference features of all video frames in the video frame group comprises:
determining, for a last video frame in the video frame group, a second reference feature of the last video frame based on the first reference feature of the last video frame;
determining, for each video frame in the video frame group except the last video frame, the second reference feature of the video frame based on the first reference feature of the video frame and the second reference feature of a subsequent video frame adjacent to the video frame, and
determining the reference feature of each video frame in the video frame group based on the second reference features of all video frames in the video frame group.

10. The method of claim 9, wherein the determining, for each video frame in the video frame group except the last video frame, the second reference feature of the video frame based on the first reference feature of the video frame and the second reference feature of a subsequent video frame adjacent to the video frame comprises:
acquiring, for each video frame in the video frame group except the last video frame, the first reference feature of a subsequent key frame of the video frame; and
determining the second reference feature of the video frame based on the first reference feature of the subsequent key frame of the video frame, the first reference feature of the video frame and the second reference feature of the subsequent video frame adjacent to the video frame.

11. The method of claim 5, wherein the determining an enhanced video frame for each video frame based on the reference information of each video frame in the video frame group and the information of each video frame comprises:
determining image enhancement information of a single channel of each video frame in the video frame group based on the reference information of each video frame in the video frame group; and
superimposing the image enhancement information of the single channel of each video frame in the video frame group with the pre-extraction feature of the video frame to acquire the enhanced video frame for each video frame in the video frame group.

12. The method of claim 8, wherein the determining the first reference feature of the video frame based on the first reference feature of the preceding key frame of the video frame, the pre-extraction feature of the video frame and the first reference feature of the preceding video frame adjacent to the video frame comprises:
performing three-dimensional convolution processing and two-dimensional convolution processing on the first reference feature of the preceding key frame of the video frame, the pre-extraction feature of the video frame and the first reference feature of the preceding video frame adjacent to the video frame, to acquire a fusion feature that fuses the first reference feature of the preceding key frame of the video frame, the pre-extraction feature of the video frame and the first reference feature of the preceding video frame adjacent to the video frame; and
removing redundant information from the fusion feature to determine the first reference feature of the video frame.

13. The method of claim 12, wherein the removing redundant information from the fusion feature to determine the first reference feature of the video frame comprises:
performing a down-sampling operation on the fusion feature using a group convolution operation to acquire the fusion feature with redundant information removed; and
performing a bilinear mapping processing on the fusion feature with redundant information removed to determine the first reference feature of the video frame.

14. (canceled)

15. A training method, comprising:
acquiring a true value of a video frame in sample video data;
encoding and decoding the video frame in the sample video data to acquire a reconstructed frame corresponding to the video frame in the sample video data;
predicting an enhanced video frame for the reconstructed frame using an apparatus under training;
calculating a value corresponding to a loss function based on the enhanced video frame and the true value of the video frame; and
adjusting parameters for respective convolution kernels and respective neurons in the apparatus based on the value corresponding to the loss function to cause the value corresponding to the loss function to converge.

16. An electronic device, comprising:
a processor; and
a memory, wherein the memory stores a computer executable program, when the computer executable program is executed by the processor, performs the method of claim 1.

17-18. (canceled)
